(19) United States
(12) Patent Application Publication
(10) Pub. No.: US 2012/0032587 A1
(43) Pub. Date: Feb. 9, 2012

(54) LED string light

(76) Inventor: Shu-Chuan Shih, Chino Hills, CA (US)

(21) Appl. No.: 12/806,168

(22) Filed: Aug. 6, 2010

(51) Int. Cl. F21V 23/00; H01J 9/00

(52) U.S. Cl. 315/32; 445/23

(57) ABSTRACT

A LED string light includes an elongated tubular casing having an elongated light cavity therewith, a light source arrangement being received within the light cavity, and a control unit electrically linking to the light source for controlling and operating the light source arrangement, so as to provide electricity thereto. The light source arrangement further includes at least one conductive wire, and a plurality of diode units spacedly and directly coupled along the conductive wire to generate a 360° light emitted from each of the diode units. Each of the diode units includes a diode sealably encased by a diode enclosure, which is encasing the diode with the conductive wire to maintain the diode in position, so as to minimize the size of the diode unit. Therefore, the diameter of the casing is reduced.

### BACKGROUND OF THE PRESENT INVENTION

1. Field of Invention

The present invention relates to a string light, and more particularly to a LED string light, wherein a plurality of diode units are spacedly and directly mounted on a conductive wire for generating 360° light emitted from the diode units, so as to minimize a diameter of the string light.

2. Description of Related Arts

The string light normally has a plurality of light bulbs mounted along an elongated wire, so as to electrically link to a power source for generating light for decoration or illumination purpose. It is also well known as a decoration light having a predetermined flexibility for generally conform a shape of an object being decorated or forming variety of shapes for lighting up the environment. For examples, placing the string light along the peripheral edges of the roof top of a house; or bending the string light to a predetermined shape for decorating the restaurant for commercial purposes.

In order to decorate the outer area, such as back yard, house, or commercial building, the string light may further comprises an outer cylindrical casing for receiving the string light therewithin, so that the string light may be able to use under the variety of weathers, such as raining.

The cylindrical casing usually made by a transparent material enclosed the wire and light bulbs therein, so that the light generated from the light bulb is able to emit through the transparent cylindrical casing. In order to maintain the characteristic of the string light, the cylindrical casing is made by the material having a predetermined flexibility, so that the string light with the cylindrical casing is able to be flexibly bended for decoration purpose while protecting the light bulb. The cylindrical casing can also prevent the wires of the string light tangled together after taking out the string light from a storage place, and prevent the light bulbs crushed with each other to cause the damage of the string light.

However, the light bulbs or LEDs mounted on the wires of the string light usually are more bulky, so that the diameter of the cylindrical casing requires a relatively larger size for accommodating the light bulbs or LEDs therewithin. Take the LED for example. Each of the LEDs comprises a diode sealably encased within a sealing enclosure, wherein two terminal ends are extended from the diode to electrically mount the LED at the wires to electrically link to a power source or control unit.

Therefore, the diameter of the cylindrical casing requires a relatively larger size for receiving the string light therewithin. The flexibility of the string light with the casing is reduced, so that the applications of the string light are limited. The string light can not be flexibly enough to conform the object and being bended to desired shape for decoration. The bulky string light also occupies a considerable storage space. It is difficult to fold or bend the string light with the bulky cylindrical casing to a compact size for storage.

Furthermore, the light generated from the diode, mounted at the wire through the two terminal ends of the diode, is limited to emit through the sealing enclosure, so that the light emitting angle is normally around 140° or less. Thus, the LEDs at the wires can not efficiently emit the light through the sealing enclosure and the cylindrical transparent casing.

### SUMMARY OF THE PRESENT INVENTION

An object of the present invention is to provide a LED string light, wherein the diodes are directly and spacedly mounted at a conductive wire to generate a 360° light emitted from the diodes.

Another object of the present invention is to provide a LED string light, wherein the diode enclosure is sealably and directly encasing each of the diodes with the conductive wire to maintain the diode at the conductive wire in position, so as to minimize the size of each of diode units.

Another object of the present invention is to provide a LED string light, wherein the diameter of the tubular casing is less than 1.27 cm (½ inch), so as to increase the flexibility of the tubular casing of the string light.

Another object of the present invention is to provide a LED string light, wherein one or more circuit wires are electrically connected to the control unit to form a circuit among the conductive wire, circuit wires, and the control unit to control and operate the light source arrangement of the string light.

Another object of the present invention is to provide a LED string light, wherein each of the circuit wires is formed via a core circuit being covered by an insulation layer, which is made by a non conductive material, so as to prevent the circuit wires electrically contacting with the conductive wire.

Another object of the present invention is to provide a LED string light, wherein the circuit wire is an enameled wire.

Another object of the present invention is to provide a LED string light, wherein one or more adaptors are provided for electrically connecting to another string light, so as to selectively prolong the overall length of the string light.

Another object of the present invention is to provide a LED string light, wherein the adaptors comprises first and second attachments, which are embodied as a plug and a socket respectively, so that the adaptors enables the string light to detachably connect with one another, so as to selectively adjust the length of the string light.

Another object of the present invention is to provide a LED string light, wherein the diode units are connected in series manner via spacedly coupling along the conductive wire.

Accordingly, in order to accomplish the above objectives, the present invention provide a LED string light, which comprises an elongated tubular casing having an elongated light cavity therewith, a light source arrangement being received within the light cavity, and a control unit electrically linking to the light source for controlling and operating the light source arrangement, so as to provide an electricity thereto.

The light source arrangement further comprises at least one conductive wire, and a plurality of diode units spacedly and directly coupled along the conductive wire to generate a 360° light emitted from each of the diode units.

Each of the diode units comprises a diode, wherein the diode is sealably encased by a diode enclosure. The diode enclosure is directly encasing the diode with the conductive wire to maintain the diode at the conductive wire in position.

Therefore, the diameter of the tubular casing is reduced due to the reduced volume of each of diode units by directly forming at the conductive wire via the diode enclosure. Thus, the volume of the string light is minimized, so as to maximize the flexibility of the tubular casing for bending the string light.

Accordingly, the present invention also provides a method for manufacturing the LED string light, which comprises the steps of followings.

(a) spacedly bonding the diodes along a conductive wire for generating a 360° light emitted from the diodes;

(b) sealably encasing the diodes by the diode enclosures respectively to retain the diodes in position along the conductive wire, so as to form the diode units thereat; and

(c) receiving the conductive wire with the diode units bonded therealong within the light cavity of the outer tubular casing.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED string light according to a preferred embodiment of the present invention.

FIG. 2 is a partial view of the LED string light according to the preferred embodiment of the present invention, illustrating a conductive wire and two circuit wires received within a light cavity of tubular casing.

FIG. 3 is a partially sectional view of the LED string light according to the preferred embodiment of the present invention.

FIG. 4 is a circuit diagram of the LED string light according to the preferred embodiment of the present invention.

FIG. 5 is a flow chart of a method for making LED string light according to the preferred embodiment of the present invention.

### DETAILED DESCRIPTION OF THE PREFERRED EMBODIMENT

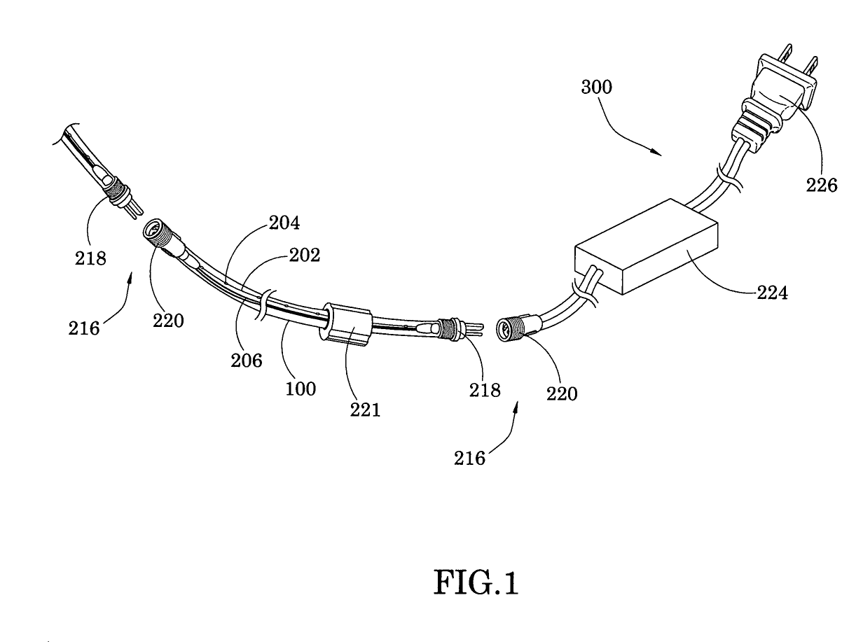

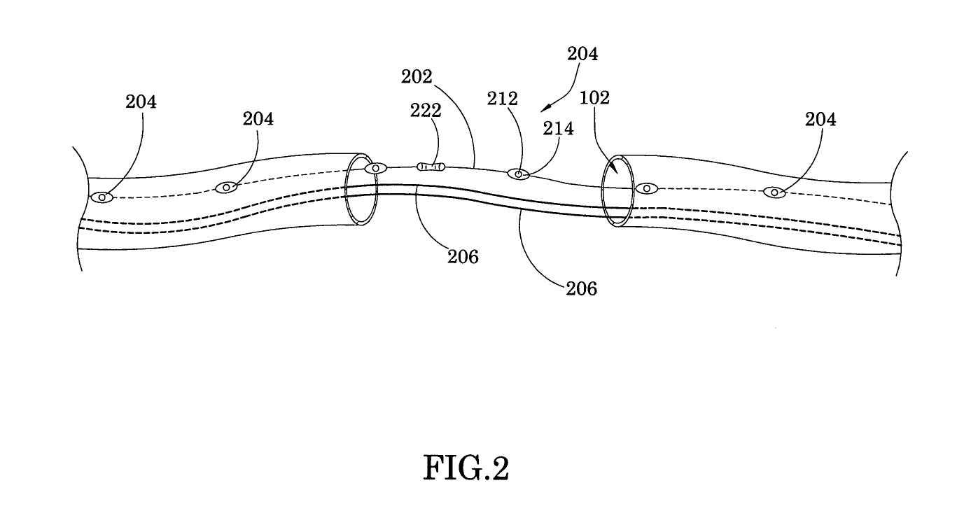

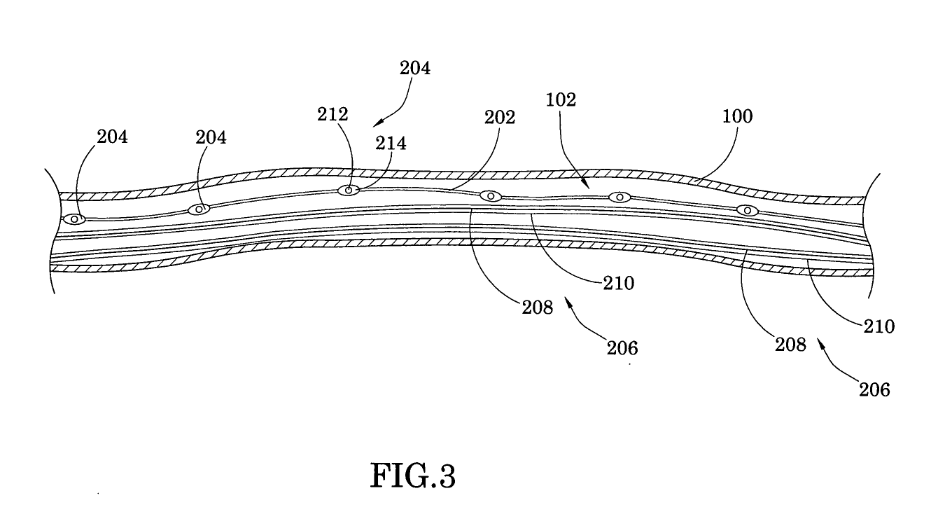

Referring to FIGS. 1 to 3, a LED string light according to a preferred embodiment of the present invention is illustrated, wherein the string light comprises an elongated tubular casing 100 defining an elongated light cavity 102 therewithin, and a light source arrangement 200 being received within the light cavity 102 of the tubular casing 100.

The tubular casing 100 is preferably made by a light transmissible material, so that a light generated from the light source arrangement 200 is able to emit the light through the light transmissible material of the tubular casing 100. The material of the tubular casing 100 also has a predetermined flexibility, so that the string light is able to be folded or bended to conform to the shape of an object.

The light source arrangement 200 comprises at least one conductive wire 202 extended within the light cavity 102 of the tubular casing 100 and a plurality of diode units 204 spacedly and directly coupled along the conductive wire 202 for generating 360° light emitted from each of said diode units 204.

The LED string light further comprises a control unit 300 electrically linking to the light source arrangement 200 for controlling and operating the light source arrangement 200, so as to provide electricity thereto for generating the light. It is appreciated that the control unit 300 may has a switch for controllably switching the power in an on-and-off manner. A control circuit may be optionally provided for setting a time period for automatically controlling the string light.

According to the preferred embodiment, the control unit 300 comprises a transformer circuit 224 electrically linking with the light source arrangement 200 and an AC adapter 226 electrically extending from the transformer circuit 224 for electrically connecting with an AC power source. Therefore, the transformer circuit 224 can transform an AC current to a DC current to the light source arrangement 200. It is appreciated that the control unit 300 can be a battery housing for receiving a replaceable battery therein so as to electrically connect to the light source arrangement 200.

As mentioned above, the light source arrangement 200 further comprises at least one circuit wire 206 electrically linking to the control unit 300 to form a circuit among the conductive wire 202, the diode unit 204, the circuit wire 206, and the control unit 300, such that the control unit 300 generates a signal and electricity to control and operate the light source arrangement 200, so as to controllably generate the light emitted from the diode unit 204.

Accordingly, two circuit wires 206 are preferably provided in the present embodiment to form the circuit, wherein each of the circuit wires 206 comprises a core wire 208 and an insulation layer 210 having a tubular structure and encasing with the core circuit 208 therewithin to form the circuit wire 206. The core wire 208 is preferably made by a conductive material for electrically linking to the control unit 300 and the conductive wire 202 to form the circuit. The insulation layer 210 is preferably made by a non conductive material, which has a much lower conductively that is insignificant to electrically transfer the electrical signals or electrons via contacting with the outer surface of the insulation layer 210 of the circuit wire 206, such that the circuit wire 206 covered by the insulation layer 210 is able to prevent the circuit wires 206 electrically contacting with the conductive wire 202 within the light cavity 102.

It is worth to mention that electrically contacting between the conductive wire 202 and circuit wire 206 may cause the shortage of the circuit, so that the diode units 204 of the light source arrangement 200 may not be able normally perform the operation to emit the light therefrom. The circuit wire 206 with the insulation layer 210 is able to efficiently and simply prevent the shortage of the circuit to stably perform the string light. The insulation layer 210 may also be provided to cover the outer surface of the conductive wire 202 only, or provided to cover both the conductive wire 202 and the core wire 206.

According to the preferred embodiment, an enameled wire is preferably used as the circuit wire 206 to prevent the conductive wire 202 electrically contacting with the enameled wire, which normally has a coating insulation at the outer surface of the enameled wire, so as to prevent electrically contacting with the conductive wire 202.

Each of the diode units 204 comprises a diode 212 directly and electrically fused at the conductive wire 202, and a diode enclosure 214 sealably encasing the diode 212 at the conductive wire 202 to retain the diode 212 in position. In other words, the diode enclosure 214 is encasing the diode 212 and the conductive wire 202 to integrally and directly form the diode unit 204 at the conductive wire 202.

Accordingly, the diodes 212 can be embodied with different properties that each of the diodes 212 can generate a particular light effect. Therefore, when the light source arrangement 200 is activated, the diodes 212 can generate different light effects, such as different colors.

The diode units 204 coupled at the conductive wire 202 is preferably connected in series in each of the string light, so that a constant current is passing through each of the diode units 204 along the same conductive wire 202.

In the preferred embodiment, the diode enclosure 214 is preferably made by resin, which is a viscous liquid having the adhesives properties being able to retain the diodes 212 at the conductive wire 202 at a predetermined position, and solidified after dried at room temperature to provide the retaining force to couple the diodes 212 with the conductive wire 202. After the resin became solid to sealably encasing the diodes 212, the solidified resin of the diode enclosure 214 becomes half transparent for allowing the light generated from the diode 212 to emit through the light transmissible solidified resin of the diode enclosure 214.

It is appreciated that the diode enclosure 214 is not limited to be made by resin. The diode enclosure 214 may be made by other materials which is able to sealably encasing the diodes 212 and retain it in position, while having the light transmissible properties when the material is turned to the solid state to retain the diode 212 at the conductive wire 202.

Accordingly, the Led light string further comprises at least an adaptor 216 for detachably and electrically coupling the light source arrangement 200 with the control unit 300. Preferably, two adaptors 216 are provided at two opposed ends of the elongated tubular casing 100 for electrically linking the light source arrangement 200. One of the adapters 216 is arranged to detachably and electrically couple with the control unit 300 so as to form the completed circuit for operating the light source arrangement 200. The other adapter 216 is arranged to detachably and electrically couple with another light source arrangement 200 via the adapter 216 thereof to prolong the length of the Led string light.

In the preferred embodiment, the two adaptors 216 preferably are a first attachment 218 and a second attachment 220. The first attachment 218 is provided at one end of the tubular casing 100 for electrically and detachably connecting the light source arrangement 200 to the control unit 300. The second attachment 220 is provided at an opposite end of the tubular casing 100 to form the completed circuit, so as for connecting to another string light via the second attachment 220, such that the first and second attachment 218, 220 are formed the completed circuit by electrically connecting the light source arrangement 200 with the control unit 300, so as to supply the electricity to the diode units 204.

In the preferred embodiment, the first attachment 218 is exemplary embodied as a plug and the second attachment 220 is exemplary embodied as a socket provided at the opposite end of the tubular casing 200. The socket of the second attachment 220 is further preferably provided at the control unit 300, so that the plug of the first attachment 218 is able to insert into the socket of the second attachment 220 at the control unit 300, so as to electrically and detachably connect the light source arrangement 200 to the control unit 300. The socket at the opposite end of the tubular casing 100 is able to electrically connect with another plug of another string light to prolong the LED string light to the predetermined length via the adaptors 216.

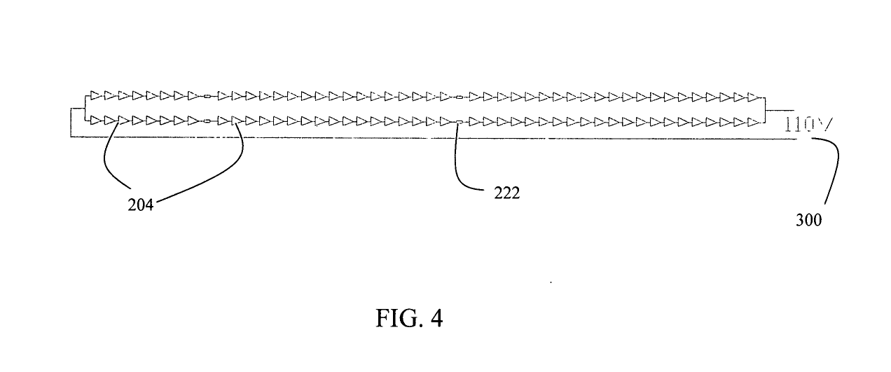

It is worth to mention that when two or more light source arrangements 200 are electrically connected via the adapters 216, the light source arrangements 200 are preferably connected in a parallel electrical connection while the diodes 212 of each of the light source arrangements 200 are electrically connected along the respective conductive wire 202 in a series electrical connection. As shown in FIG. 4 as an example of the present invention, there are totally two light source arrangements 220 being connected in parallel electrical connection to the control unit 300, wherein each of the light source arrangements 220 has forty-six diode units 204 and two resistors 22 connected along the conductive wire 202 in a series electrical connection.

In order to securely and electrically coupling the first and second attachment 218, 220, a cap 221 having an inner threaded portion provided at the first attachment 218 may further provided for rotatably and detachably engaging with an outer threaded portion of the second attachment 220, such that after the plug and socket of first and second attachment 218, 220 are detachably coupled with each other, the cap 221 is able to rotatably secure the first attachment 218 with the second attachment 220.

It is appreciated that the first and second attachments 218, 220 of the adaptors 216 are interchangeable. The adaptor 216 may only comprises the first attachment 218 or the second attachment 220 formed at one end of the tubular casing 100 for electrically connecting to the control unit 300.

As mentioned above, the size of each of the diode units 204 is minimized due to the diode 212 is directly coupled at the conductive wire 202 and being integrally encased via the diode enclosure 214 to directly seal the diode 212 and the partial conductive wire 202 to form the diode unit 204, so as to generate the 360° light.

Therefore, the diameter of the tubular casing 100 is able to be reduced, wherein the diameter of the tubular casing 100 of the present invention is able to be less than 1/2″, preferably 1/8″, so as to minimize the volume of the string light and enhance the flexibility of the elongated tubular casing 100 of the string light.

The string light of the present invention not only increases the flexibility and minimizes the size of the tubular casing 100, but also efficiently enhances the light intensity by generating the 360° light. It can be easily bended to conform to a shape of an object for decoration or decoratively lighten up the environment.

The minimized diameter of the tubular casing 100 has a size for conveniently applying in variety of areas and objects, while given a predetermined strength to support the light source arrangement 200. The relatively smaller diameter of the tubular casing 100, which is able to prevent the conductive wire 202 with the diode units 204 and the circuit wires 206 tangling together, also minimizes the space for storing the LED string light.

As described above, one or more resistors 222 may further provided to electrically linking to the light source arrangement 200 for adjusting the currently and/or voltage of string light. The resistors 222 are preferably connected with the diode units 204 in series manner to balance the circuit of the string light.

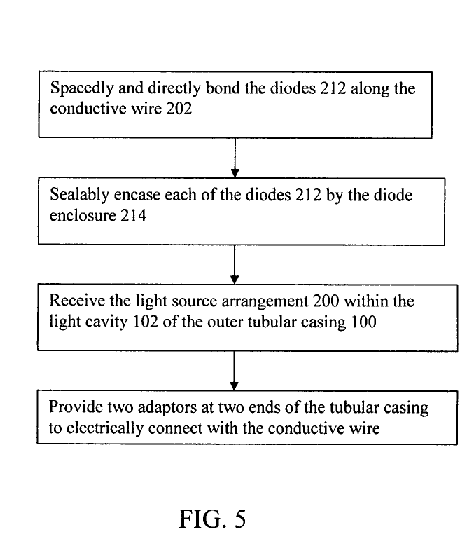

Referring to FIG. 5 of the drawings, a method of making LED string light is also provided, wherein the method comprises the steps of followings.

(a) Spacedly and directly bond the diodes 212 along the conductive wire 202 for generating a 360° light emitted from the diodes 212.

(b) Sealably encase each of the diodes 212 by the diode enclosure 214 to retain the diode 212 in position along the conductive wire 202, so as to form the diode units 214 thereat formed by each of the diodes 212 encased by each of the diode enclosure 214. Therefore, the diode enclosure 214 is integrally formed with the diodes 212 and the partial conductive wire 202 to emit the 360° light therefrom.

(c) Receive the conductive wire 202 with the diode units 204 bonded therealong within the light cavity 102 of the outer tubular casing 100.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED string light, comprising an outer tubular casing having an elongated light cavity therewithin, wherein said outer tubular casing is made by a light transmissible material having a predetermined flexibility;
a light source arrangement provided within said light cavity, which comprises:
at least one elongated conductive wire being received within said light cavity of said outer tubular casing; and
a plurality of diode units spacedly and directly coupling along said conductive wire for generating 360° light emitted from each of said diode units; and
a control unit electrically linking to said light source arrangement via linking to said conductive wire for controlling an operation of said light source arrangement, so as to controllably activate said diode units for generating said light therefrom.

2. The LED string light, as recited in claim 1, wherein said light source arrangement further comprises at least one elongated circuit wire received within said light cavity of said tubular casing at a position that said circuit wire is insulated and shield for preventing conductively contacting with said conductive wire within said light cavity.

3. The LED string light, as recited in claim 2, wherein said circuit wire comprises an elongated core wire having a predetermined conductivity to form a circuit with said conductive wire and an elongated insulation layer encasing with said core wire to prevent said conductive wire directly and electrically contacting with said core wire.

4. The LED string light, as recited in claim 2, wherein said circuit wire is an enameled wire.

5. The LED string light, as recited in claim 3, wherein said circuit wire is an enameled wire.

6. The LED string light, as recited in claim 1, wherein each of said diode units comprises a diode directly fused at said conductive wire to electrically link to said control unit, and a diode enclosure sealably encasing said diode at said conductive wire to directly couple said diode at said conductive wire and to retain said diode in position.

7. The LED string light, as recited in claim 3, wherein each of said diode units comprises a diode directly fused at said conductive wire to electrically link to said control unit, and a diode enclosure sealably encasing said diode at said conductive wire to directly couple said diode at said conductive wire and to retain said diode in position.

8. The LED string light, as recited in claim 5, wherein each of said diode units comprises a diode directly fused at said conductive wire to electrically link to said control unit, and a diode enclosure sealably encasing said diode at said conductive wire to directly couple said diode at said conductive wire and to retain said diode in position.

9. The LED string light, as recited in claim 1, wherein said tubular casing has a diameter less than ½ inch.

10. The LED string light, as recited in claim 3, wherein said tubular casing has a diameter less than ½ inch.

11. The LED string light, as recited in claim 8, wherein said tubular casing has a diameter less than ½ inch.

12. The LED string light, as recited in claim 1, wherein said diode units are electrically and spacedly connected along said conductive wire in a series electrical connection.

13. The LED string light, as recited in claim 8, wherein said diode units are electrically and spacedly connected along said conductive wire in a series electrical connection.

14. The LED string light, as recited in claim 11, wherein said diode units are electrically and spacedly connected along said conductive wire in a series electrical connection.

15. The LED string light, as recited in claim 1, further comprising two adaptors provided at two ends of said tubular casing to electrically connect with said light source arrangement, wherein one of said adapters is detachably coupled with said control unit to electrically link said control unit with said light source arrangement while another said adapter is adapted to detachably couple with another said light source arrangement so as to electrically link said two light source arrangements in a parallel electrical connection.

16. The LED string light, as recited in claim 8, further comprising two adaptors provided at two ends of said tubular casing to electrically connect with said light source arrangement, wherein one of said adapters is detachably coupled with said control unit to electrically link said control unit with said light source arrangement while another said adapter is adapted to detachably couple with another said light source arrangement so as to electrically link said two light source arrangements in a parallel electrical connection.

17. The LED string light, as recited in claim 14, further comprising two adaptors provided at two ends of said tubular casing to electrically connect with said light source arrangement, wherein one of said adapters is detachably coupled with said control unit to electrically link said control unit with said light source arrangement while another said adapter is adapted to detachably couple with another said light source arrangement so as to electrically link said two light source arrangements in a parallel electrical connection.

18. A method for manufacturing a LED string light, which comprises the steps of:
(a) spacedly bonding a plurality of diodes along a conductive wire for generating a 360° light emitted from said diodes;
(b) sealably encasing said diodes by a plurality of diode enclosures to retain said diodes in position along said conductive wire, so as to form a plurality of diode units thereat; and
(c) receiving said conductive wire with said diode units bonded therealong within an elongated light cavity of an outer tubular casing.

19. The method, as recited in claim 18, further comprises a step of receiving at least one circuit wire within said light cavity of tubular casing to form a circuit with said conductive wire, wherein said circuit wire is insulated and shield for preventing conductively contacting with said conductive wire within said light cavity.

20. The method, as recited in claim 19, wherein said circuit wire comprises an elongated core wire having a predetermined conductivity to form said circuit with said conductive wire and an elongated insulation layer encasing with said core wire to prevent said conductive wire directly and electrically contacting with said core wire.

21. The method, as recited in claim 20, wherein said circuit wire is an enameled wire.

22. The method as recited in claim 18 wherein, in the step (a), said diodes are directly fused at said conductive wire.

23. The method as recited in claim 21 wherein, in the step (a), said diodes are directly fused at said conductive wire.

24. The method, as recited in claim 18, wherein said tubular casing has a diameter less than ½ inch.

25. The method, as recited in claim 23, wherein said tubular casing has a diameter less than ½ inch.

26. The method, as recited in claim 18, wherein said diodes are electrically and spacedly connected along said conductive wire in a series electrical connection.

27. The method, as recited in claim 25, wherein said diodes are electrically and spacedly connected along said conductive wire in a series electrical connection.

28. The method, as recited in claim 18, further comprising a step of providing two adaptors at two ends of said tubular casing to electrically connect with said conductive wire, wherein one of said adapters is detachably coupled with a control unit to electrically link said control unit with said diodes while another said adapter is adapted to detachably couple with another said conductive wire so as to electrically link said two conductive wires in a parallel electrical connection.

29. The method, as recited in claim 27, further comprising a step of providing two adaptors at two ends of said tubular casing to electrically connect with said conductive wire, wherein one of said adapters is detachably coupled with a control unit to electrically link said control unit with said diodes while another said adapter is adapted to detachably couple with another said conductive wire so as to electrically link said two conductive wires in a parallel electrical connection.
